(19) United States
(12) Patent Application Publication
(10) Pub. No.: US 2010/0172703 A1
(43) Pub. Date: Jul. 8, 2010

(54) SPHERICAL MILLING CUTTER

(76) Inventor: Karl-Heinz Neubold, Oelbronn-Duerrn (DE)

Correspondence Address: DRINKER BIDDLE & REATH (DC), 1500 K STREET, N.W., SUITE 1100, WASHINGTON, DC, 20005-1209, US

(21) Appl. No.: 12/449,801

(22) PCT Filed: Feb. 26, 2008
(86) PCT No.: PCT/EP2008/052308

§ 371 Date: Mar. 18, 2010

(30) Foreign Application Priority Data
Feb. 28, 2007 (DE) 10 2007 010 163.7

(51) Int. Cl. B23C 5/10

(52) U.S. Cl. 407/53

(57) ABSTRACT

The present invention concerns a spherical milling cutter having a shaft and a cutting part which has at least one cutting edge disposed on a spherical surface. To provide a spherical milling cutter having the features set forth in the opening part of the specification which are more efficient in terms of metal removal rate and roughness depth than conventional spherical milling cutters of the same nominal diameter, and which are nonetheless in a position to produce finer concave contours than a conventional spherical milling cutter of the same nominal radius, it is proposed in accordance with the invention that the cutting part has at least two cutting edges which are respectively on at least two different spherical surfaces, the radius of which is at least equal to the nominal radius.

The present invention concerns a spherical milling cutter having a shaft and a cutting part which has at least one cutting edge disposed on a spherical surface.

Corresponding spherical milling cutters whose cutting portions in a side view follow a circular arc which starting from one side from the cutting part firstly begins with a portion which is approximately parallel to the axis and from there extends by way of a constant radius of curvature to the tip or to the centre of the boring tool, are known in the state of the art. The name spherical milling cutter in that respect vividly describes the appearance of such a milling cutter, the cutting part of which in a side view appears in the form of a sphere or part of a sphere. The cutting edge or a portion corresponding to the cutting portion just described is continued on the diametrally opposite side in the case of milling cutters with an even number of cutting edges, and extends from the centre or from the axis by way of an arc of the same radius and the same centre point of curvature towards the other side where it runs out in approximately parallel relationship with the axis.

For reasons of simplified systematology such a cutting edge which extends through or over the axis is considered in accordance with the present invention as a (single) cutting edge as it extends along a continuous circular arc with a constant radius and a single fixed centre point of curvature, although it is clear that, when the cutting edge passes through the axis of the milling cutter, the direction of the true rakes is self-evidently reversed so that it would also be possible to talk of two cutting edges which respectively extend from the periphery along an arc to the centre of the milling cutter or the zenith of a notional spherical surface. In the region of the axis (or at the zenith of the spherical surface) the cutting edge in question can therefore have a short transitional cutting edge or transverse cutting edge, point thinning portions or an interruption. Irrespective of whether the cutting edge is considered throughout as one cutting edge or only the portions extending from the axis are respectively viewed in themselves as being dedicated cutting edges, the feature common to all conventional spherical milling cutters still remains however, that all cutting edges of a conventional spherical milling cutter are disposed on a common spherical surface.

It will be noted however that the cutting edges do not necessarily also have to be disposed in a plane containing the axis of the milling cutter, but they can also include certain peripheral components and for example can extend along a helical line around the axis of the milling cutter on the periphery of a notional sphere.

Such spherical milling cutters generally serve for the production of any workpiece surfaces, in particular workpiece surfaces which are one-dimensionally or two-dimensionally curved, even if the production of flat surfaces by means of spherical milling cutters is not excluded, in which respect it will be noted however that flat surfaces are generally more rationally produced with face milling cutters or shaft-type milling cutters or end milling cutters and also many (axially short) surfaces curved only in one direction, with shaft-type milling cutters.

The surfaces produced with spherical milling cutters however generally involve a markedly greater roughness depth than the surfaces which are flat or which are curved only in one direction and which are produced with the above-mentioned types of milling cutters. In concrete terms, the roughness depth depends on the one hand on the so-called ‘line feed’ (when the spherical milling cutter is moved along the surface to be produced in line-wise relationship, that is to say along substantially parallel lines with a certain line spacing or line width), and the tooth feed, that is to say the feed along such a line per cutting tooth or per cutting edge. Basically the situation is that, the greater the line width and the greater the feed movement per tooth, the correspondingly greater is also the roughness depth. In practice therefore the line width and the tooth feed are so adjusted that the desired surface is produced, with an acceptable roughness depth.

In that respect, besides the above-mentioned operating parameters, the roughness depth is also dependent in particular on the nominal diameter or nominal radius of the spherical milling cutter, that is to say the radius of the spherical surface on which the cutting edges are disposed. In that respect it is basically the case that, with a given line feed and a given tooth feed, the roughness depth is correspondingly less, the greater the diameter or radius of the spherical milling cutter.

It will be noted however that spherical milling cutters with a larger radius suffer from the disadvantage that finer structures or tight concave curvatures in respect of the surfaces, which have a smaller radius than the spherical milling cutter, cannot be produced directly therewith. Rather, re-working operations are required for that purpose, using other tools or further spherical milling cutters of a smaller radius. That makes the use of spherical milling cutters with a large nominal radius uneconomical in many cases.

In comparison with that art the present invention is based on the problem of providing a spherical milling cutter having the features set forth in the opening part of this specification, which is more efficient in terms of metal removal rate and roughness depth than conventional spherical milling cutters of the same nominal diameter and which is nonetheless in a position to produce finer contours.

That problem is solved in that at least one cutting edge which extends on average predominantly in a direction parallel to the axis at the periphery of the cutting part of the milling cutter extends on a spherical surface whose centre point as viewed from the cutting edge lies on the other side of the milling cutter axis.

That means at the same time that the cutting edge extending at the periphery also defines the nominal radius of the milling cutter, and that the radius of the spherical surface on which the said cutting edge extends is larger than the nominal radius of the milling cutter.

Such a spherical milling cutter, with its relatively slightly curved cutting edge, that is to say its cutting edge which is disposed on a sphere of large sphere radius, produces a relatively wide flat cutting contour which, with a given line width and a given tooth feed, produces a correspondingly slight roughness depth. As however that cutting edge is at the same time at a maximum spacing relative to the milling cutter axis, which defines the nominal radius of the milling cutter and which is less than the radius of curvature of the cutting edge, such a milling cutter can also be used to produce concave structures, the radius of curvature of which is markedly smaller than the radius of the sphere.

In accordance with an embodiment it is provided that the cutting part has at least two cutting edges which are respectively disposed on at least two different spherical surfaces, the radius of which is respectively larger than the nominal radius of the milling cutter.

Such a spherical milling cutter therefore has cutting edges on spherical surfaces, the radius of which is larger than the nominal radius of the milling cutter, which at the same time has the consequence that the cutting edges can no longer be disposed on a common spherical surface but the two spherical surfaces which belong to the at least two different cutting edges are in turn different from each other.

In that respect, in accordance with an embodiment, the radii of the different spherical surfaces can be equal so that the spherical surfaces differ only by the position of their centre points. It will be appreciated that it is also possible to provide spherical surfaces of different radii on one and the same spherical milling cutter provided only that the condition is satisfied that there are at least two cutting edges which are respectively disposed on another spherical surface.

Like all spherical milling cutters the spherical milling cutter according to the invention also has exclusively curved cutting edges which are disposed on spherical surfaces if any bevels or transitions between cutting edges disposed on different spherical surfaces are disregarded, which can have a common cutting corner or a transitional region which is formed with a markedly smaller radius than that of the above-mentioned spherical surfaces or with a bevel or chamfer.

Desirably the cutting edges are disposed in a meridian plane or more generally on great circles of corresponding spherical surfaces, in which respect however curvatures in respect of the cutting edges perpendicularly to a great circle plane are not in principle excluded. Those curvatures perpendicularly to a meridian plane or a plane defined by a great circle should however as far as possible not deviate considerably from the curvature of the spherical surface and should preferably not be of a smaller radius of curvature than the sphere.

In accordance with an embodiment at least two of the at least two cutting edges are arranged symmetrically relative to the axis of the milling cutter, that is to say after rotation through a given angle of rotation about the axis of the milling cutter, which is less than 360° and which for example can be a fraction 1/n, with n=2, . . . 12, of 360°, a cutting edge exactly assumes the previous position of another one. Certain slight deviations from such rotational symmetry are also admissible, for example for avoiding vibration, as long as at least two of the cutting edges are disposed on a common rotational surface about the axis of the milling cutter, which in a plane containing the axis involves the curvature of spherical surfaces with different centre points of curvature and which in the plane perpendicular to the axis is of a smaller radius than the spherical surfaces, wherein that radius of the rotational surface defines the nominal radius of the milling cutter.

In a further embodiment, besides at least one cutting edge disposed on such a rotational surface, there is at least one cutting edge which is disposed on a spherical surface and the centre point of which is on or in the proximity of the axis and which at the same time also extends through or towards the axis. That cutting edge is disposed, expressed in vivid terms, on a spherical segment, through the centre of which extends the axis of the milling cutter. The position of such a cutting edge therefore corresponds to the position of the end cutting edges on a shaft-type milling cutter, but differs from the end cutting edges of a shaft-type milling cutter by virtue of their constant curvature about a centre point of curvature on the axis of the milling cutter.

Preferably the radius of the spherical surfaces is at least 10% larger than the nominal radius and in particular at least 30% larger than the nominal radius.

In addition in accordance with an embodiment of the invention the radius of the spherical surfaces is limited to a maximum of ten times, preferably a maximum of five times, the nominal radius. It was possible to achieve very good results with spherical milling cutters having a plurality of cutting edges on spherical surfaces, the radius of the sphere of which was between 1.5 times and 5 times, for example being 4 times, the nominal radius (limit values included).

In that respect in accordance with an embodiment the angle sector over which a corresponding cutting edge extends should be at least 30° and better still at least 40°.

In general the angle over which such a cutting edge extends however is smaller than 120° and preferably also smaller than 90°. In that respect the various cutting edges which in themselves respectively involve a larger radius of curvature than corresponds to the nominal radius are so arranged on the cutting part that overall they are embraced by an enveloping cylindrical surface (with the axis of rotation of the milling cutter as the axis of the cylinder), the radius of which corresponds to the nominal radius. The length of the uninterrupted cutting edges extending on a given spherical surface, in accordance with an embodiment, should respectively correspond to at least approximately 40% of the nominal radius, better still approximately half or even better at least 0.8 times the nominal radius.

The maximum length of a cutting edge extending on a given spherical surface should be not more than 2.5 times the nominal radius, for example not more than twice the nominal radius, and should preferably be below 1.8 times the nominal radius. At least one of the cutting edges should be a so-called ‘peripheral surface cutting edge’, that is to say a cutting edge which, averaged over its length, extends substantially in the axial direction or in the peripheral direction, that is to say approximately parallel to a notional cylinder peripheral surface, with the axis of the milling cutter as the axis of the cylinder. Such a peripheral surface cutting edge should have a centre point of curvature which, viewed from the axis of the milling cutter, is on the side of the axis that is opposite to the cutting edge, which is already a necessary condition for the reason that otherwise the nominal radius could not be smaller than the radius of the spherical surface on which the cutting edge extends.

In accordance with an embodiment of the invention there is further provided at least one end cutting edge, that is to say a cutting edge which, averaged over its length, extends substantially perpendicularly to the axis of the milling cutter. The centre point of curvature of such an end cutting edge should be disposed on the axis or at least in the proximity of the axis of the spherical milling cutter, more specifically at a maximum spacing from the axis, that corresponds to ten times the nominal diameter.

Such an end cutting edge can extend through the axis or beyond the axis and, if the end cutting edge is of a continuous configuration on both sides of the axis, it is considered in the context of the present description as a single cutting edge, even if on passing through the axis the direction in which the respective true rake surface faces reverses. Any point thinnings or transverse cutting edges at the point of intersection of such a cutting edge with the axis can obviously be present, but do not in any way alter consideration of the cutting edge disposed on the same spherical surface as being ‘a’ cutting edge.

Otherwise the end cutting edges could also be respectively measured only from the axis. The foregoing angular values and peripheral length values, over which corresponding cutting edges should preferably extend in accordance with the foregoing description are however based on (at least) one respective cutting edge extending beyond the axis. If the portions of that cutting edge on both sides of the axis are to be viewed as separate cutting edges then those angular values and peripheral lengths would be correspondingly halved.

In accordance with a further embodiment of the present invention it is provided that at least a part of the cutting edges disposed on different spherical surfaces blend into each other, in which case those transitions are formed by cutting corners which can be rounded to a greater or lesser degree but which could also be sharp-edged or almost sharp-edged. The maximum corner radius of such transitional regions, for an embodiment of the invention, is 0.2 times the nominal radius or less, and preferably those cutting corners or transitional regions have radii of less than a tenth of the nominal radius and down to a hundredth of the nominal radius. As mentioned, sharp-edged transitions are also not excluded, but for reasons of stability of the cutting corners it is preferable if the transition radius is at lest one hundredth of the nominal radius or a bevel at that location is at least of the width of a hundredth of the nominal radius. The width of a corresponding bevel or chamfer can also be up to 0.2 times the nominal radius, but is preferably narrower than a tenth of the nominal radius.

In an embodiment of the invention there are provided in diametrally opposite relationship two peripheral surface cutting edges which are connected together by an end cutting edge, wherein cutting corners with the above-mentioned smaller corner radius are respectively provided at the transition between end cutting edges and peripheral cutting edges. It will be appreciated that instead of two it is also possible to provide four (or more) peripheral cutting edges which are respectively displaced relative to each other through about 90° (or 360°/n, wherein n is the number of peripheral cutting edges), wherein in addition there can also be two (or more) mutually crossing end cutting edges which interconnect the peripheral cutting edges in question, in which respect it will be noted however that one of the end cutting edges, at the point of intersection with the other in the region of the axis, could have a short interruption, for example in the form of a point thinning.

Because of the predominantly lateral feed (perpendicularly to the axis) of such a spherical milling cutter, the precise provision of the end cutting edges at the centre, that is to say in the proximity of the axis of the milling cutter, is only of slight significance as, with a moderate tooth feed, the surface in front of the axis is already removed before the cutting edge regions directly in the region of the axis can come into engagement with the workpiece and as the feed can also have components which are in part axially rearwardly directed and which prevent contact in respect of the end cutting edges directly at the point of passage through the axis.

Further advantages, features and possible uses of the present invention will be apparent from the description hereinafter of preferred embodiments and the related Figures in which:

FIG. 1 diagrammatically shows a side view of a first embodiment of a milling cutter according to the invention,

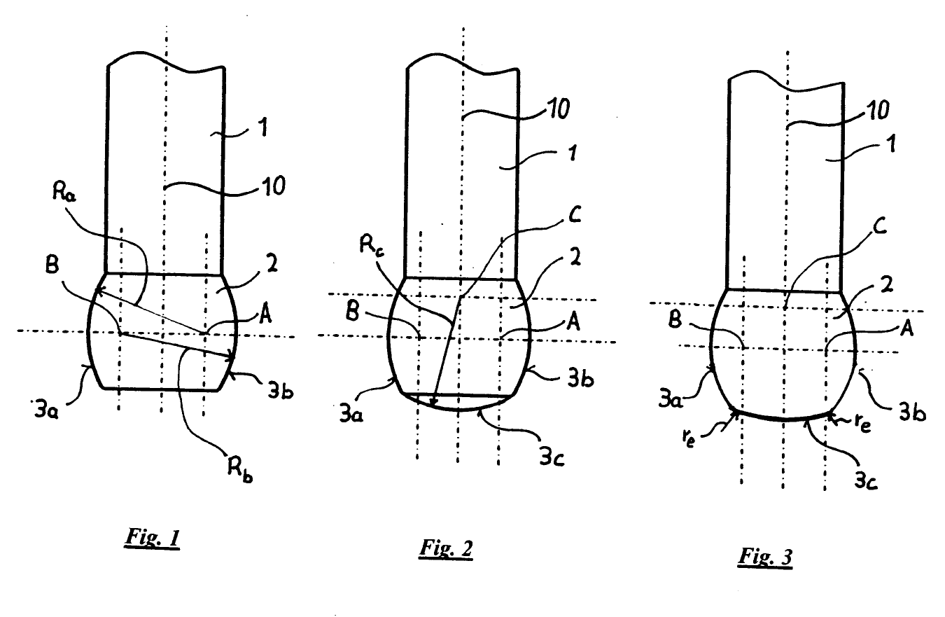

FIG. 2 shows a side view of a second embodiment,

FIG. 3 shows a side view of a third embodiment,

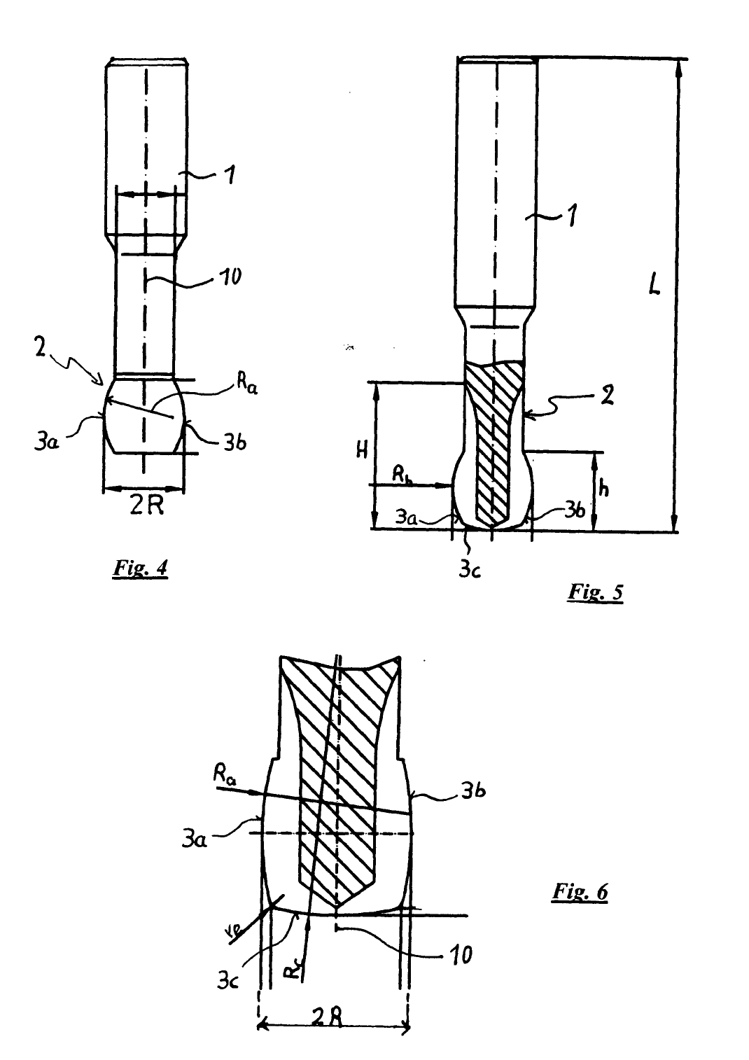

FIG. 4 shows a side view of a complete milling cutter in accordance with the first embodiment,

FIG. 5 shows a side view, partly in section, of a complete milling cutter in accordance with the second embodiment, and

FIG. 6 shows a view also in section and on a somewhat enlarged scale of the cutting part of a variant of the third embodiment.

Referring to FIG. 1 shown therein is a milling cutter having a shaft 1 and a cutting part 2 with two diametrally opposite cutting edges 3a, 3b which are respectively disposed on a spherical surface, the radius Rₐ, R_{b} of which is larger than the nominal radius R, that is to say larger than half the maximum diameter of the cutting part, measured perpendicularly to the axis 10.

Two dash-dotted lines extending parallel to the axis 10 and crossed by a horizontal line mark the position of the centre points A and B respectively of curvature of the cutting edges 3a and 3b respectively disposed on the other side of the axis 10. As therefore the centre points of curvature A and B are at a greater spacing from the spherical surfaces which are respectively associated therewith and on which the cutting edges 3a and 3b respectively extend, than the axis 10 of the milling cutter, the radii of curvature Rₐ, R_{b} are correspondingly larger than the nominal radius R and in the present case are about 50% (or somewhat more) greater than the nominal radius R. This type of milling cutter is suitable essentially for contouring surfaces which extend at an only relatively slight inclination or parallel to the axis of the milling cutter. In specific terms the inclination of corresponding surfaces relative to the axis of the milling cutter should not be substantially more than the inclination of the tangent to the front end of the cutting edges 3a, 3b in order not to excessively stress the cutting corners there.

FIG. 2 shows a type of milling cutter which in regard to the two peripheral surface cutting edges 3a, 3b is substantially identical to the type of milling cutter shown in FIG. 1 but which in addition also has an end cutting edge 3c which also lies on a spherical surface, the centre point of curvature C of which is in turn in a different position from the centre points of curvature A and B of the two peripheral cutting edges 3a, 3b. In this case the radii Rₐ, R_{b} and R_{c} are all the same, but it would be readily possible in particular for the radius R_{c} to be selected to be smaller than or larger than the radii Rₐ, R_{b} which in turn however should preferably be the same. The transition between the peripheral cutting edges 3a and 3b and the end cutting edge 3c defines in this case a pronounced cutting corner, that is to say the tangents applied in the proximity of that cutting corner to the end cutting edge and the peripheral cutting edge involve a different inclination and the transition from the one cutting edge to the other is relatively abrupt with a very small, almost disappearing radius or by way of a small bevel, the width of which should be not more than a fifth and better at most a tenth of the nominal radius.

In the illustrated embodiments the centre points of curvature A, B are disposed on a common plane perpendicularly to the axis 10 which divides the cutting part approximately in the axial centre. It will be appreciated however that this plane can also be readily displaced upwardly or downwardly, which as the outcome amounts to a shorter portion (extending in approximately axis-parallel relationship) of the cutting edge remaining either above or below that plane, than on the respective other side.

The third type of milling cutter as shown in FIG. 3 again has the same peripheral surface cutting edges 3a, 3b with the same position of the centre points of curvature A, C as in the case of the first-mentioned and second-mentioned type and this milling cutter also once again has an end cutting edge like the second type, but in this case the end cutting edge has a more greatly rounded transition to the peripheral cutting edges so that the inclination of a tangent to the cutting edges in the region of the transition continually changes in the transition from the end cutting edge to the peripheral cutting edge and vice-versa. The radius of curvature rₑ at that transition is however markedly smaller than one of the radii Rₐ, R_{b} or R_{c} and in particular is even smaller than the nominal radius R, wherein values of less than 20% or better still at most 10% of the nominal radius R are preferred for that transitional radius rₑ.

FIG. 4 shows once again a type of milling cutter similar to that shown in FIG. 1, with a completely illustrated shaft 1. As will be seen the radius of curvature

Rₐ is about 70% greater than the nominal radius R. All cutting edges are disposed on a rotational surface about the axis 10 which in a plane containing the axis is of the curvature Rₐ (=R_{b}) while the maximum rotational radius of that surface corresponds to the radius R.

FIG. 5 shows a milling cutter of the second type, that is to say with a pronounced cutting corner which is almost sharp-edged or has a very small transitional radius of the order of magnitude of 1/100 R to an end cutting edge 3c which involves the same radius of curvature as the peripheral cutting edges, but a different centre point of curvature which is on the axis 10. In this case also the radii of curvature of the cutting edges are about 70% greater than the nominal radius.

FIG. 6 shows an embodiment of the third type which in this case differs from the embodiment of the second type in FIG. 5 not only by a somewhat larger transitional radius for the cutting corner (for example rₑ=1/10R), but also by the radius of curvature which is still markedly larger in comparison with the nominal radius R (for example Rₐ=R_{b}=R_{c}=about 4R) than in the case of the milling cutter shown in FIG. 2. As also in FIG. 5, the cutting part is shown here in section so that at the centre it is possible to see the hatched core of the milling cutter while the outer continuous line defines the envelope or the position of the peripheral cutting edges 3a, 3b.

It will be appreciated that a corresponding spherical milling cutter can in principle have any number of peripheral surface cutting edges which should preferably be arranged approximately symmetrically relative to the axis, that is to say at substantially equal peripheral angular spacings. In the simplest case the milling cutter according to the invention either has only has two peripheral cutting edges or one peripheral cutting edge and an end cutting edge, in which respect it would be sufficient if the end cutting edge extends only on one side of the axis to the peripheral cutting edge in question. Preferred milling cutters however are spherical milling cutters having at least two diametrally opposite cutting edges or milling cutters with an even larger number of peripheral cutting edges 3a, 3b which all lie on the same envelope rotational surface which could also be described as a ‘barrel shape’. The end cutting edges are not necessarily provided in all embodiments, but corresponding milling cutters with end cutting edges are preferred for most situations of use, in which respect in a variant associated with each peripheral cutting edge is an end cutting edge which extends approximately to the centre or to the axis 10 and the end cutting edge in question and the peripheral cutting edge respectively define a cutting corner at their transition. It will be noted however that the number of peripheral cutting edges can also be larger or smaller than the number of any end cutting edges, the latter being preferred as somewhat fewer. By way of example the number of peripheral cutting edges can be twice as large as the number of end cutting edges, in which case then a corresponding end cutting edge can be associated at most with each second peripheral cutting edge.

The radii of curvature Rₐ, R_{b} of the peripheral cutting edges can be readily different from the radii of curvature R_{c} of the end cutting edges, even if both are respectively larger than the nominal radius R.

As the spherical milling cutter according to the invention has cutting edges of relatively large radii the roughness depths with a given line width and a given tooth feed are correspondingly small (as long as the line width and the tooth feed are less than the nominal radius). At the same time however the diameter or nominal radius of such a milling cutter is markedly smaller than that of a conventional spherical milling cutter, the nominal radius of which is the same as the radius of the spherical surfaces on which the cutting edges extend. That also makes it possible to produce substantially finer contours with concave radii of curvature which are markedly smaller than the radius of the peripheral cutting edges 3a, 3b and the end cutting edge 3c, wherein production of those tighter concave radii of curvature involves using the cutting corners or the transitional region between the end cutting edges and the peripheral cutting edges.

In addition with the same metal removal rate the milling cutter according to the invention produces a better surface quality (smaller roughness depth) on the workpiece than a conventional spherical milling cutter or with the same roughness depth it affords a better metal removal rate due to a larger line width and/or a greater tooth feed. When foregoing the respective maximum metal removal rate or minimum roughness depth, it is also possible to improve both performance parameters at the same time in comparison with conventional spherical milling cutters.

1. A spherical milling cutter having a shaft and a cutting part which has at least one cutting edge disposed on a spherical surface, wherein at least one cutting edge which extends on average predominantly in a direction parallel to the axis at the periphery of the cutting part of the milling cutter extends on a spherical surface whose centre point as viewed from the cutting edge lies on the other side of the milling cutter axis.

2. A spherical milling cutter according to claim 1, wherein that the cutting part has at least two cutting edges which are respectively disposed on at least two different spherical surfaces, the radius of which is larger than the nominal radius.

3. A spherical milling cutter according to claim 1, wherein the radius of the spherical surfaces is at least 1.1 times the nominal radius.

4. A spherical milling cutter according to claim 1, wherein the radius of the spherical surfaces is respectively at a maximum 10 times the nominal radius.

5. A spherical milling cutter according to claim 1, wherein the cutting edges extend on their respective spherical surfaces over an angle sector of at least 30°.

6. A spherical milling cutter according to claim 1, wherein the cutting edges extend on their respective spherical surfaces over an angle sector of a maximum of 120.

7. A spherical milling cutter according to claim 1, wherein the length of each of the cutting edges corresponds to at least 40% of the nominal radius.

8. A spherical milling cutter according to claim 1, wherein the peripheral length of the cutting edges on the spherical surface is at a maximum 2.5 times the nominal radius.

9. A spherical milling cutter according to claim 1, which has at least one cutting edge which averaged over its length extends substantially in the axial direction (peripheral surface cutting edge), the centre point of curvature of which is on the side opposite to the cutting edge in relation to the axis.

10. A spherical milling cutter according to claim 1, wherein the cutting part has at least one cutting edge which averaged over its length extends substantially perpendicularly to the axis (end cutting edge) and the centre point of curvature of which is on the axis or is spaced from the axis within a spacing of at most a tenth of the nominal radius.

11. A spherical milling cutter according to claim 1, wherein at least a part of the cutting edges continuously merges into each other.

12. A spherical milling cutter according to claim 11, wherein the transition between cutting edges which merge into each other is by way of a cutting corner.

13. A spherical milling cutter according to claim 11, wherein the cutting corner is bevelled by a chamfer.

14. A spherical milling cutter according to claim 13, wherein the chamfer is of a width which is between 1/100 and 1/5 of the nominal radius.

15. A spherical milling cutter according to claim 12, wherein the cutting corner has a transitional radius which is at most 0.2 times the nominal radius.

16. A spherical milling cutter according to claim 15, wherein the transitional radius is less than a tenth of the nominal radius.

17. A spherical milling cutter according to claim 15, wherein the transitional radius is larger than a hundredth of the nominal radius.

18. A spherical milling cutter according to claim 1, wherein the milling cutter has at least two peripheral cutting edges and at least one end cutting edge which extends symmetrically relative to the axis of the milling cutter.

19. A spherical milling cutter according to claim 9, wherein the end cutting edge extends through the axis, wherein the direction in which the true rake of the end cutting edge faces changes where the end cutting edge passes through the axis.

20. A spherical milling cutter according to claim 1, wherein there are two or more end cutting edges which, starting from a cutting corner, extend at the transition to a peripheral cutting edge in the direction of the axis, and wherein the two end cutting edges are on the same spherical surface.

21. A spherical milling cutter according to claim 1, wherein the shaft is of a radius which is smaller than the nominal radius defined by the maximum radius of the cutting part.

22. A spherical milling according to claim 20, wherein at least one of the cutting edges extends to the axis.
